(19) United States
(12) Patent Application Publication
(10) Pub. No.: US 2008/0293903 A1
(43) Pub. Date: Nov. 27, 2008

(54) Optical Organic Polymer

(76) Inventors: Maria Petrucci-Samija, Wilmington, DE (US); Bao-Ling Yu, Chadds Ford, PA (US)

Correspondence Address: Santopietro, Lois A;E.I. Du Pont De Nemours and Company, Legal Patent Records Center, 4417 Lancaster Pike, Wilmington, DE, 19805, US

(21) Appl. No.: 11/658,237

(22) PCT Filed: Sep. 14, 2005
(86) PCT No.: PCT/US2005/033110

§ 371 Date: Jan. 23, 2007

Related U.S. Application Data
(60) Provisional application No. 60/609,880, filed on Sep. 14, 2004.

(51) Int. Cl. C08F 18/20; C08F 16/24

(52) U.S. Cl. 526/246; 528/401; 526/247

(57) ABSTRACT

An organic polymer suitable for preparing optical waveguides or optical fibers and methods of making same are described. The polymer is a homo- or copolymer having an olefinic backbone with a pendant group comprising fluorinated aromatic and aliphatic moieties, and is cross-linkable. Polymers having refractive index over a wide range may be prepared by selecting specific constituents of the pendant group.

### FIELD OF THE INVENTION

The present invention is directed to a novel organic polymer useful for preparation of integrated optical components with application in optical communications systems.

### BACKGROUND OF THE INVENTION

It has long been known to employ transparent organic polymers in the preparation of components useful in optical communications systems. The art teaches both optical fibers and optical waveguides. Optical fibers are freestanding extended structures, typically circular in cross-section, and usually in the form of a cable, which are capable of being used to convey optical communications signals over distances on the order of kilometers. An optical waveguides is typically disposed upon a substrate such as a silicon wafer, typically having a quadrilateral cross-section, often rectangular, and which is employed as a switch, channel selector, coupler and the like. It is known to form both optical fibers and optical waveguides from transparent organic polymers. A typical waveguide is shown in FIG. 1, wherein a cladding layer (101), a waveguide core (102), a buffer layer (103) and a Si substrate (104) are illustrated.

In the current state of the art, organic polymers are most often employed in the fabrication of integrated optical chips wherein multiple devices of diverse function are combined on a single chip. The near infrared (NIR) is a wavelength region of current practical interest, particularly at 1.55 nm, the emission wavelength of He—Ne lasers. Organic polymers suitable for use in the fabrication of integrated optical devices for use at 1.55 nm are known in the art.

Organic polymers characterized by sufficient transparency (typically <0.3 dB/cm) provide benefits over inorganic materials such as silica for the fabrication of integrated optical devices. Certain organic polymers are readily photo-patterned. Under some circumstances organic polymers can be fabricated into final devices without the need for finishing processes such as ion etching. Organic polymers also exhibit much higher thermo-optic and lower stress-optic coefficients than does silica, making them particularly well suited for switching functions. Moreover, organic polymers can be coated over large areas and fabricated into patterns using equipment that is less expensive than that required for processing silica. In addition, organic polymers are ideal hosts for optically non-linear dopants useful for modulation and switching optical frequency communications signals.

Desirable properties for an organic polymer candidate for integrated optical communications applications include
Optical loss <0.3 db/cm at 1.3-1.55 μm wavelength;
Lowest possible birefringence to minimize polarization dependent losses;
Refractive index high enough to match that of silica and adjustable over a wide enough range to match various doped silicas;
Dimensional stability, either by virtue of high cross-link density or high glass transition temperature;
Good processing properties, particularly in the form of high solubility in inexpensive solvents.
Good chemical resistance, water resistance and the like.

Numerous efforts have been made to prepare organic polymers having those attributes. However, there are many trade-offs made in the art. For example, low optical loss at 1.55 μm is associated with highly fluorinated organic polymers. However, substituting hydrogen with fluorine results in a refractive index considerably below that of silica. Furthermore high degrees of fluorination are associated with poor solubility in ordinary, inexpensive non-fluorinated solvents. Introduction of aromatic groups tends to increase refractive index, but also increases lossiness and can increase birefringence. Fluorination of the aromatic group will decrease lossiness as well as refractive index, but then reduces processability. In general, the fluorinated aliphatic species exhibit lower loss than the fluorinated aromatic species.

Fedynshyn et al., U.S. Patent Application Publication US2002/0160297, discloses photoresist compositions of homo- and copolymers of perfluoroisopropanol-styrenes, comonomers being fluorinated and non-fluorinated aliphatic substituted styrenes, as well as non-fluorinated or slightly fluorinated acrylates. Terpolymers are also disclosed.

Toshikuni et al., JP1993066437A, discloses a copolymer of a fluoroalkyl methacrylate and a non-fluorinated aromatic bisazo methacrylate suitable for use in optical waveguides and related optical communications components. The copolymer of Toshikuni et al is disclosed to exhibit a refractive index of 1.47 versus that of silica that is 1.444, and disclosed to exhibit an optical loss at 1.55 μm of 0.5 dB/cm versus the goal of <0.3 dB/cm. No optical components are taught.

Ding et al., International Publication WO 03/099907, discloses arylene ether organic polymers and oligomers having olefinic end-groups for use in telecommunication applications as switches, filters, beam splitters, and the like. No teaching of actual devices is therein present.

Andrews et al., International Publication WO 03/054042, discloses copolymers of pentafluorostyrene with highly fluorinated aliphatic acrylates and glycidyl methacrylate. Preparation of integrated optical devices and waveguides is taught.

Lee et al., U.S. Pat. No. 6,627,383, discloses a photoresist monomer composition comprising an acrylic derivative of hexafluorobisphenol compounds, wherein the aromatic rings thereof are substituted or not substituted. The phenolic hydrogen is replaced by an acid labile protecting group that may contain an aromatic ring. Copolymers of monomers with and without the acid labile protecting group are disclosed, as well as terpolymers, which include various styrene derivatives including tetrafluorostyrene (but not pentafluorostyrene).

Allen et al., U.S. Patent Application Publication 2002/0164538, discloses photoresist compositions comprising copolymerization of a styrene monomer substituted with a fluorine containing moiety and a fluorinated or non-fluorinated acrylic monomer to form a styrene acrylate copolymer. The aromatic monomer is described by the structure (I).

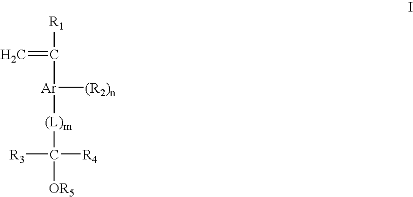

where m is 0 or 1; 0<n<4; R₁ is H, F, lower alkyl or fluoroalkyl; R₂ is alkyl, fluorinated alkyl, hydroxyl, alkoxy, fluorinated alkoxy, halogen, or cyano; R₃ is fluorinated alkyl; R₄ is H, alkyl, or fluorinated alkyl; R₅ is H, alkyl, protected hydroxyl; —C(O)R₈, —CH₂C(O)OR₉, —C(O)OR₉, or —SiR₁₀, where R₈ is H or alkyl, R₉ is alkyl, and R₁₀ is alkyl or alkoxy; L is hydrocarbylene and may include an aromatic portion. Ar is an aromatic moiety, which may include a plurality of aromatic rings either fused or directly linked.

Takuma, JP06116555A2, discloses optical stabilizer for dyes including 4,4′-[2,2,3,3,3-pentafluoro-1-(pentafluoroethyl)propylidene]bis[2-(1,1-dimethylethyl)-6-methyl phenol].

Kashimura et al., U.S. Pat. No. 5,800,955, discloses 4,4′-(2,2,3,3,4,4,5,5,6,6,7,7,8,8,9,9,10,10,11,11,12,12,13,13,14,14,15,15,16,16,17,17,17-tritriacontafluoro-1-methylheptadecylidene)bis[phenol] and 4,4′-[3,3,4,4,5,5,6,6,7,7,8,8,9,9,10,10,11,11,12,12,13,13,14,14,14-pentacosafluoro-1-(trifluoromethyl)tetradecylidene]bis[phenol].

Yamamoto et al., JP02097514A2, discloses 4,4′-(2,2,3,4,4,5,5,6,6,7,7,8,8,9,9-pentadecafluoro-1-methylnonylidene)bis-phenol and 4,4′-2,2,3,4,4,5,5,6,6,7,7,8,8,8-tetradecafluoro-1-methyloctylidene)bis-phenol and the epoxidized derivatives thereof.

Ohsaka et al., U.S. Pat. No. 4,946,935, discloses 4,4′-[4,5,5,5-tetrafluoro-4-(heptafluoropropoxy)-1-(trifluoromethyl)pentylidene]bis-phenol.

### SUMMARY OF THE INVENTION

The present invention provides an organic polymer comprising monomer units represented by the structure

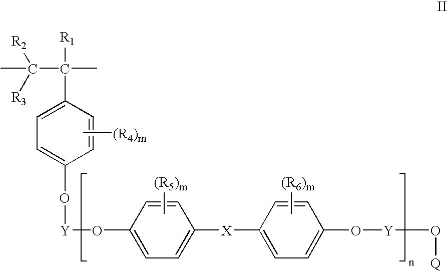

where n is an integer equal to 0 to 2, each of R₁, R₂, and R₃ is independently H, F, or lower alkyl, with the proviso that no more than one of R₁, R₂, and R₃ can be F at one time; each m is independently an integer equal to 0 to 4; each of R₄ is independently F, Cl, or lower fluoroalkyl; each of R₅ is independently H, F, lower alkyl, or lower fluoroalkyl, each of R₆ is independently H, F, lower alkyl, or lower fluoroalkyl; X is a bond, an ether oxygen, a carbonyl, or

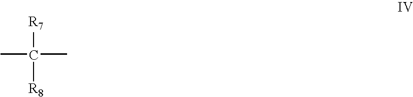

where R₇ and R₈ each is independently H, F, or fluoroalkyl, with the proviso that if R₇ is H or F then R₈ must be fluoroalkyl; Y is a diradical having the formula

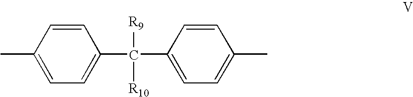

where R₉ and R₁₀ is each independently H, F, or fluoroalkyl, with the proviso that only one of R₉ or R₁₀ may comprise an alkyl or fluoroalkyl chain of more than two carbons, and with the further proviso that if R₉ is H or F, R₁₀ is fluoroalkyl; and, Q is H, an unsaturated group suitable for use as a cross-linking site, or a radical having the formula

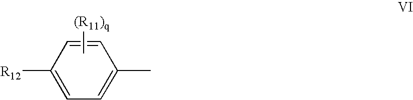

where q=1-4, each of R₁₁ is independently F or H, and R₁₂ is a cross-linkable alkenyl or a protected alkenyl.

### BRIEF DESCRIPTION OF THE FIGURES

FIG. 1 shows schematically one embodiment of a waveguide comprising the organic polymer of the invention, a silicon wafer, a buffer layer, a guiding layer, and a cladding layer; and the refractive indices of the layers.

FIG. 2 shows a schematic flow chart of a microfabrication process for preparing an optical waveguide using the polymer of the invention in a wet-etch process.

FIG. 3 shows optical photomicrographs of two waveguides of differing in width made according to Example 10.

FIG. 4 shows the refractive index vs. wavelength of a waveguide fabricated according to Example 10.

FIG. 5 shows a scanning electron micrograph of a waveguide fabricated in Example 10.

FIG. 6 shows schematically seven different integrated optical devices, which can be fabricated from the polymer of the invention.

FIG. 7 displays graphically the effect of polymer composition on refractive index.

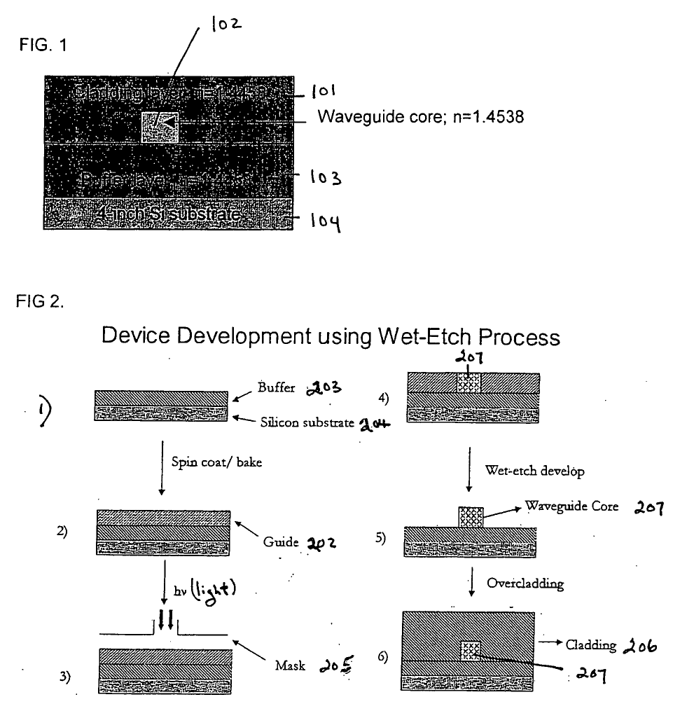

### DETAILED DESCRIPTION

The present invention is directed to the on-going need in the art to provide optical organic polymers that meet the above-outlined performance criteria.

According to the present invention is provided an organic polymer that is highly soluble in common solvents by virtue of its substantially olefinic backbone and is cross-linkable by ordinary means to provide, in the cross-linked state, high dimensional stability and toughness. The organic polymer of the present invention exhibits very low optical loss in the near infrared (NIR) while exhibiting a tunable refractive index that can be adjusted to equal that of pure or doped silicas. Refractive index adjustment is effected by choosing specific embodiments of the organic polymer of the invention according to the means herein described.

The term “lower” when applied to alkyl, fluoroalkyl, alkoxy, and fluoroalkoxy groups shall be understood to refer to such groups comprising up to 4 carbons—that is, for example lower alkyl shall be understood to encompass methyl, ethyl, propyl, and butyl.

The term “copolymer” as used herein will be understood to encompass organic polymers made up of two or more genera of monomer units. Thus, the term “copolymer” will be understood to encompass ter-polymers, tetra-polymers, and so on, as well as di-polymers.

One of skill in the art will appreciate from the structures herein presented, that the di-radical elements of the olefinic polymer chain backbone and the side chains or pendant groups thereon, encompass many specific embodiments. Unless it is specifically stated to the contrary or the description is expressly limited to a single species, the terms “homopolymer,” “homopolymerized” and the like shall be understood to include those embodiments wherein a plurality of species encompassed by the same generic description are polymerized together. Thus, specifically, a homopolymer comprising monomer units represented by the Structure II shall be understood to encompass any combination of specific monomer units all of which are encompassed within the generic Structure II. In a similar vein, the homopolymerization of the monomer of Structure IIc shall be understood to encompass the plurality of monomer species all falling under the generic description of Structure IIc.

However, when the structure referred to is more limiting than Structure II, then the term “homopolymer” shall be understood to encompass only those embodiments of the invention that are encompassed by the more limiting structure. For example, if a homopolymer of Structure IIa is referred to, then only those embodiments of which the structures are encompassed by Structure IIa are referred to.

Similar considerations will be understood to apply in the use of the terms “copolymer,” “comonomer,” and “copolymerization”. For the purposes of the present invention the term “copolymer” will be understood to mean the combination of at least two species of monomers, each from a distinct generically defined monomer or monomeric diradical. However, the indicated terms shall further be understood to encompass a plurality of species representing one or more genera. There are no limitations according to the present invention of the number of monomeric species, which can be employed in the formation of the organic polymer of the invention.

In order to limit excess verbiage, shorthand terms will be employed herein wherein structures herein depicted and labeled by Roman numerals and alphabetic characters, indicated herein to be structures representing di-radical monomer units, radicals, monomers and so forth. The structures will then subsequently be referred to by the Roman numeral designation thereof using terms, such as, for example, “the monomer IIc” which will be understood to mean “the monomer represented by the Structure IIc.”

The present invention provides for an organic polymer comprising monomer units represented by the structure

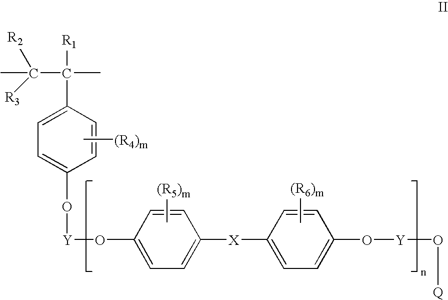

where n is an integer equal to 0 to 2; each of R₁, R₂, and R₃ is independently H, F, or lower alkyl, with the proviso that no more than one of R₁, R₂, and R₃ can be F at one time; each m is independently an integer equal to 0 to 4; each of R₄ is independently F, Cl, or lower fluoroalkyl; each of R₅ is independently H, F, lower alkyl, or lower fluoroalkyl, each of R₆ is independently H, F, lower alkyl, or lower fluoroalkyl; X is a bond, an ether oxygen, a carbonyl, or

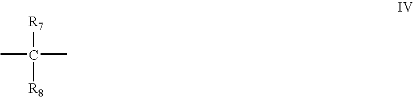

where R₇ and R₈ each is independently H, F, or fluoroalkyl, with the proviso that if R₇ is H or F then R₈ must be fluoroalkyl; Y is a diradical having the formula

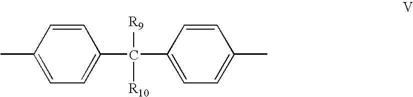

where R₉ and R₁₀ is each independently H, F, or fluoroalkyl, with the proviso that only one of R₉ or R₁₀ may comprise an alkyl or fluoroalkyl chain of more than two carbons, and with the further proviso that if R₉ is H or F, R₁₀ is fluoroalkyl; and, Q is H, an unsaturated group suitable for use as a cross-linking site, or a radical having the formula

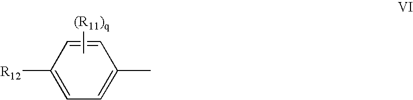

where q=1-4, each of R₁₁ is independently F or H, and R₁₂ is a cross-linkable alkenyl or a protected alkenyl.

Suitable cross-linkable groups include alkenyl, alkynyl and epoxy functionalities. Protecting groups include hydroxyl, trimethylsilyl groups, and bromine (in the form of HBr added to a double bond).

In one embodiment, R₁, R₂, and R₃ are all H.

According to the present invention, each m is an integer equal to 0 to 4 and each of R₄ is independently F, Cl, or lower fluoroalkyl. In one embodiment, each of R₄ is F or lower fluoroalkyl. In a further embodiment each of R₄ is F. Further according to the present invention, each of R₅ is independently H, F, lower alkyl, or lower fluoroalkyl, and each of R₆ is independently H, F, lower alkyl, or lower fluoroalkyl. In one embodiment, R₅ and R₆ are correlated with each other according to the scheme

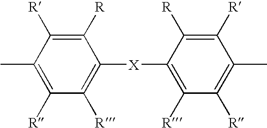

In a further embodiment, R, R′, R″, and R′″ are all F.

According to the present invention, X is a bond, an ether oxygen, a carbonyl, or

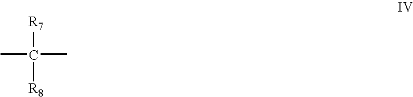

where R₇ and R₈ each is independently H, F, or fluoroalkyl, with the proviso that one of R₇ and R₈ can be neither H nor F if the other is either H or F. In one embodiment, X is represented by structure IV, and R₇ and R₈ are both perfluoromethyl radicals. In another embodiment, X is ether oxygen.

According to the present invention, Y is a diradical represented by Structure V

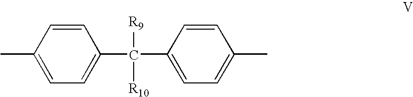

where each of R₉ and R₁₀ is independently H, F, or fluoroalkyl, and with the proviso that only one of R₉ or R₁₀ may comprise a fluoroalkyl chain of more than two carbons, and with the further proviso that if R₉ is H or F, R₁₀ is fluoroalkyl. In one embodiment, R₉ and R₁₀ are both perfluoromethyl radicals, perfluoroethyl radicals, or one of each. In a further embodiment, one of R₉ and R₁₀ is a perfluoromethyl or perfluoroethyl radical, and the other is a radical represented by the structure

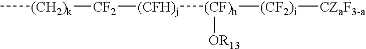

where k=0-2, j=0 or 1, h=0 or 1, i=1-20, Z is F or H, a=0-2, and R₁₃ is a perfluoroalkyl radical of 1-20 carbons, k, i, and a all being integers.

In a further embodiment, one of R₉ and R₁₀ is a perfluoromethyl or perfluoroethyl radical, and the other is selected from the group consisting of

### —(CF₂)₁₋₂₀—CF₃,

### —CH₂—(CF₂)₁₋₂₀—CF₃,

### —CF₂—CFH—(CF₂)₁₋₂₀—CF₃,

### —CF₂—CFH—(CF₂)₁₋₂₀—CHF₂,

### —CF₂—CFH—CF₃, and

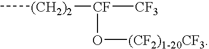

According to the present invention, Q is H, an unsaturated group suitable for use as a cross-linking site, a radical having the formula

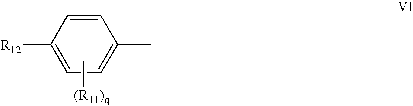

where q is an integer equal to 0 to 4, wherein said radical each of R₁₁ is F or H, and R₁₂ is a cross-linkable alkenyl or a protected alkenyl. In one embodiment each of R₁₁ is F.

In yet a further embodiment, the organic polymer of the invention comprises monomer units represented by Structure IIa

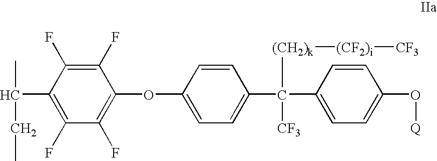

where k=0-2, and i=1-20, k and i being integers, and, Q is H, an unsaturated group suitable for use as a cross-linking site, or a radical having the formula

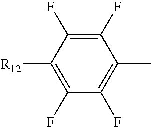

where R₁₂ is

H₂C═CH—

or a protected derivative thereof.

In a still further embodiment the organic polymer of the invention comprises monomer units represented by the formula IIb.

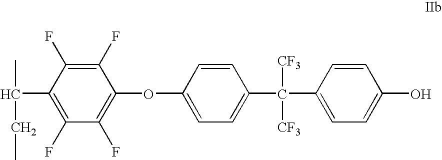

In one embodiment, the organic polymer of the invention is a homopolymer consisting essentially of monomer units represented by Structure II. In a further embodiment, the organic polymer of the invention is a copolymer. Suitable comonomers include but are not limited to fluorostyrenes, particularly pentafluorostyrene, and derivatives thereof, fluorinated acrylates, particularly highly fluorinated acrylates such as 1H,1H-perfluoro-n-alkylacrylate wherein said alkylacrylate comprises a linear chain of 4-20 carbons. Suitable acrylate monomers include, but are not limited to, 1H,1H-perfluoro-n-octyl acrylate; 1H,1H-perfluoro-n-decyl acrylate; 1H,1H-perfluoro-n-octyl methacrylate; 1H,1H-perfluoro-n-decyl methacrylate; 1H,1H,9H-hexadecafluorononyl acrylate; 1H,1H,9H-hexadecafluorononyl methacrylate; and, 1H,1H,2H,2H-heptadecafluorodecyl acrylate.

One embodiment of the copolymer of the invention comprises monomer units of Structure II combined with monomer units represented by Structure VII

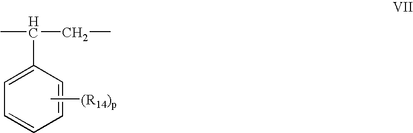

where p is an integer equal to 0 to 5 and each R₁₄ is independently F, Cl, alkyl, fluoroalkyl, alkoxy, and fluoroalkoxy. In a further embodiment each R₁₄ is independently F, alkyl, fluoroalkyl. In a further embodiment still, R₁₄ is F, and p is 1-5. In a still further embodiment, R₁₄ is F and p=5.

In another embodiment, the copolymer of the invention comprises monomer units represented by Structure II combined with monomer units of the Structure VIII:

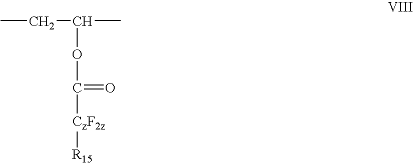

where z is an integer equal to 1 to 20, and R₁₅ is trifluoromethyl or an unsaturated group suitable for use as a cross-linking site.

In a still further embodiment, the organic polymer of the invention comprises monomer units of Structure II in combination with monomer units of Structure VII and monomer units of Structure VIII. In yet a further embodiment, the organic polymer of the invention comprises monomer units of Structure IIa in combination with monomer units of Structure VII wherein R₁₄ is F and p=5, and Structure VIII. In a still further embodiment, the organic polymer of the invention comprises monomer units of Structure IIb in combination with monomer units of Structure VII wherein R₁₄ is F and p=5 and Structure VIII.

In a further embodiment of the organic polymer or copolymer hereof, the organic polymer or copolymer is cross-linked at the location of R₁₂, R₁₅, or both, and where R₁₂, R₁₅, or both are then diradical residues of the unsaturated groups after the cross-linking has taken place.

There is no limit to the relative proportions of the comonomers in the copolymer of the invention. It is found in the practice of the invention that copolymers comprising 60-90 mol-% of comonomer VII, 5-20 mol-% of comonomer VIII, and 5-20 mol-% of comonomer II exhibit refractive indices in the vicinity of silica with optical absorption loss of <0.3 dB/cm.

The organic polymer of the present invention may advantageously be prepared by using conventional methods of free-radical addition polymerization of a monomer of Structure IIc,

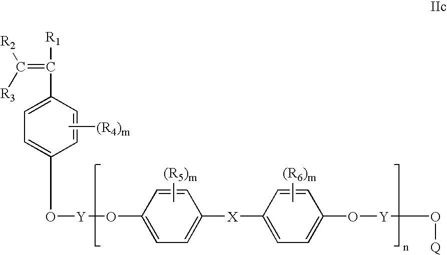

wherein R₁, R₂, R₃, R₄, R₅, R₆, Y, X, m, n, and Q are defined as hereinabove with the exception that Q does not comprise an unsaturated group suitable for cross-linking. However, Q may comprise a protected group which when deprotected will then be an unsaturated group suitable for cross-linking.

In one embodiment of the monomer IIc R₁, R₂, and R₃ are each H, F, or lower alkyl with the proviso that no more than one of R₁, R₂, and R₃ can be F or lower alkyl at one time. In a further embodiment, R₁, R₂, and R₃ are all H.

In one embodiment of the monomer IIc, each of R₄ is F. In one embodiment, R₅ and R₆ are correlated with each other according to the scheme

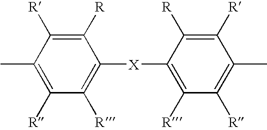

In a further embodiment, R, R′, R″, and R′″, are all F.

In another embodiment of the monomer IIc, X is represented by structure IV, and R₇ and R₈ are both perfluoromethyl radicals. In another embodiment, X is ether oxygen

In another embodiment of the monomer IIc, R₉ and R₁₀ are perfluoromethyl radicals, perfluoroethyl radicals, or one of each. In a further embodiment, R₉ is a perfluoromethyl or perfluoroethyl radical, and R₁₀ is a radical represented by the structure

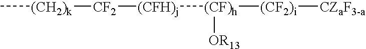

where k=0-2, j=0 or 1, h=0 or 1, i=1-20, Z is F or H, a=0-2, and R₁₃ is a perfluoroalkyl radical of 1-20 carbons, k, i, and a being integers.

In a further embodiment, R₉ is a perfluoromethyl or perfluoroethyl radical, and R₁₀ is selected from the group consisting of

### —(CF₂)₁₋₂₀—CF₃,

### —CH₂—(CF₂)₁₋₂₀—CF₃,

### —CF₂—CFH—(CF₂)₁₋₂₀—CF₃,

### —CF₂—CFH—(CF₂)₁₋₂₀—CHF₂,

### —CF₂—CFH—CF₃, and

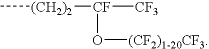

In a further embodiment of the monomer IIc hereof, in reference to the embodiment of Q depicted as Structure VI, each of R₁₁ is F, lower alkyl or lower fluoroalkyl. In a further embodiment each of R₁₁ is F.

In yet a further embodiment, the monomer IIc is represented by Structure IId

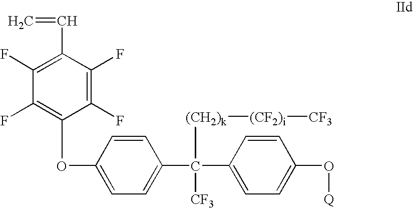

where k=0-2, and i=1-20, and, Q is H, an unsaturated group suitable for use as a cross-linking site, or a radical having the formula

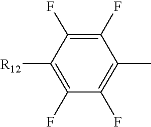

where R₁₂ is a protected derivative of

H₂C═CH—

In a further embodiment the monomer IIc is represented by the formula IIe.

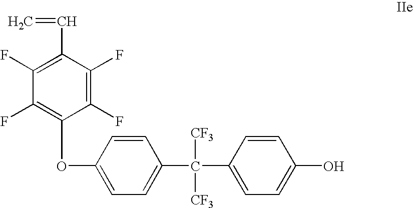

Addition polymerization of the monomer of Structure IIc may be accomplished according to the teachings of the art for conventional olefin polymerizations to form both the homopolymer and the copolymer of the present invention. Particularly pertinent is the process for free-radical polymerization of styrene as described in detail in Chapter 9, pp. 323-334 of Organic Polymer Chemistry, 5^{th} ed., by Charles E. Carraher, Jr., Marcel-Dekker (2000). Suitable free radical initiators include but are not limited to 2,2′-azobisisobutyronitrile, phenylazotriphenylmethane, tert-butyl peroxide, cumyl peroxide, acetyl peroxide, benzoyl peroxide, lauroyl peroxide, tert-butyl hydroperoxide, tert-butyl perbenzoate. Essentially any free-radical initiator known to be useful in olefin polymerizations may be employed to initiate the polymerization of monomer represented by Structure IIc.

Any method of polymerization commonly employed in the preparation of polyolefins may be employed, including bulk, solution, suspension, emulsion and the like. It is found in the practice of the invention that solution polymerization employing aromatic solvents may advantageously be performed. Suitable solvents include many typical organic solvents such as are routinely employed in the art, including but not limited to toluene, benzene, tetrahydrofuran, ethyl acetate, propyl acetate, cyclopentanone.

Polymerization may be effected both at atmospheric pressure or in a pressurized autoclave, preferably in a dry, inert atmosphere such as dry nitrogen. The temperature of polymerization must be higher than that required for activation of the initiator, but otherwise it is desirable to maintain a polymerization temperature that provides a suitable balance between conversion and reaction time. In a typical olefin polymerization, depolymerization tends to be increasingly favored with increasing temperature. However, the overall conversion also proceeds more quickly at higher temperatures. One of skill in the art will appreciate that selection of the initiator will largely determine the acceptable range of temperatures for a given reaction. One of skill in the art will also appreciate that different specific monomer compositions will have an effect on polymerization rates and molecular weight of the final product. Initiator concentration also has major effects on molecular weight and chain transfer, as described in Chapter 9 of Carraher Jr., op. cit.

It has been found satisfactory in the preparation of the organic polymer hereof to employ benzoyl peroxide to initiate polymerization in a reaction mixture at 80-85° C. at atmospheric pressure in a nitrogen purged vessel with a reaction time of 16-18 hours. More broadly, reaction times may vary from 4 to 24 hours depending upon the initiator employed and concentration used.

In one embodiment, the organic polymer hereof is a homopolymer as hereinabove defined said homopolymer being prepared by polymerizing according to the process herein described one or more species of monomers encompassed in monomer IIc.

In another embodiment, the organic polymer hereof is a copolymer as hereinabove defined, said copolymer being prepared by copolymerizing at least one species from each of at least two generically different monomer genera as hereinabove defined. In one embodiment, monomer IIc is combined with a monomer represented by the Structure VIIa

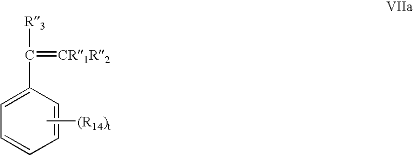

where t=1-4, R″₁, R″₂, and R″₃ are each independently H, F, or lower alkyl with the proviso that no more than one of R″₁, R″₂, and R″₃ can be F or lower alkyl at one time. In a further embodiment, each of R₁, R₂, and R″₃ is H. In a further embodiment, monomer VIIa is fluorostyrene. In a still further embodiment, monomer VIIa is pentafluorostyrene.

More specifically, at least one species encompassed by monomer VIIa is copolymerized with at least one species encompassed by monomer IIc to form the organic polymer of the present invention.

In a further embodiment of the process for preparing the organic polymer of the invention, monomer IIc is copolymerized with a monomer represented by the structure

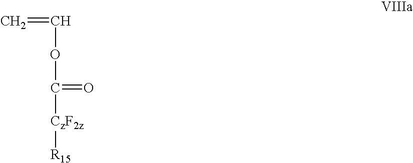

where z=1-20, and R₁₅ is trifluoromethyl or a protected unsaturated group which when deprotected is suitable for use as a cross-linking site.

In a still further embodiment, the organic polymer of the invention is prepared by the copolymerization of monomer IIc with comonomers VIIa and VIIIa. More specifically, one embodiment of the organic polymer of the invention is prepared by the copolymerization of at least one species of monomer IIc with at least one species of monomer VIIa and at least one species of monomer VIIIa.

In one embodiment monomer IIe is combined with pentafluorostyrene, and 1H,1H-perfluoro-n-alkyl acrylate wherein the perfluoroalkyl moiety consists of a linear carbon chain of from 4 to 20 carbons. Suitable acrylate monomers include but are not limited to: 1H,1H-perfluoro-n-octyl acrylate; 1H,1H-perfluoro-n-decyl acrylate; 1H,1H-perfluoro-n-octyl methacrylate; 1H,1H-perfluoro-n-decyl methacrylate; 1H,1H,9H-hexadecafluorononyl acrylate; 1H,1H,9H-hexadecafluorononyl methacrylate; and 1H,1H,2H,2H-heptadecafluorodecyl acrylate. In a further embodiment, the 1H,1H-perfluoro-n-alkyl acrylate is 1H,1H-perfluoro-n-decyl acrylate or 1H,1H-perfluoro-n-dodecyl acrylate.

Monomers VIIa are available commercially from Sigma Aldrich Company, and a variety of specialty chemical synthesis companies, or may alternatively be prepared according to methods taught in the art. Monomers VIIIa are available commercially from Exfluoro Research Co. Monomer IIc may be prepared according to the method of Ding et al., op. cit., in combination with the method of Yamamoto et al., op. cit, or, in the alternative, with the method of Takuma, op. cit.

The monomer IIc is desirably prepared by forming a fluorinated derivative of bisphenol-A and reacting that derivative with a styrenic monomer to form either a vinyl phenol or a diene.

According to the process of Ohsaka et al., op. cit., one equivalent of a compound of the formula X′COY′ is reacted with somewhat more than two equivalents of a compound of the formula A-H in the presence of a Lewis acid to form a compound of the formula

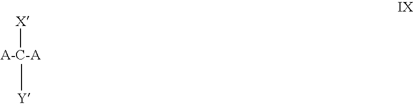

For the purposes of the present invention, A is 4-hydroxy phenyl or 4-hydroxy ortho or meta toluoyl. X′ is

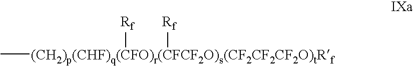

where R_{f} is a perfluoroalkyl group having 1 to 10 carbons, R_{f} is a perfluoroalkyl group having 1 to 12 carbons, p is an integer from 1 to 3, q is an integer from 0 to 3, r is 0 or 1, s is an integer from 0 to 5, and t is an integer from 0 to 5. Y′ is X′, H, an alkyl group having 1 to 8 carbons, or a perfluoroalkyl group having 1 to 8 carbons.

According to Ohsaka the compound X′COY′ is prepared by a Grignard reaction the ketone wherein X′ is as represented in structure IXa and Y′ is perfluoromethyl.

Further according to the method of Ohsaka, the thus prepared X′COY′ is reacted with phenol or toluol in the presence of a Lewis acid to form the compound IX. Suitable Lewis acids include hydrogen fluoride, aluminum chloride, iron (III) chloride, zinc chloride, boron trifluoride, HSbF₆, HAsF₆, HPF₆, HBF₄, and others such as are known in the art. Hydrogen fluoride is preferred. According to the process for forming the compound IX, 15 to 100 moles of Lewis acid, preferably 20 to 50 moles of Lewis acid, are used per mole of X′COY′. Hydrogen fluoride may serve a double role as both Lewis acid and solvent.

The reaction of X′COY′ and phenol or toluol to form compound IX is carried out at a temperature from 50 to 200° C., preferably from 70 to 150° C., at a pressure of 5 to 20 kg/cm², preferably from 7 to 15 kg/cm². Depending upon the specifics of the reactants, temperature, and pressure, the reaction time will be in the range of 1 to 24 hours under most circumstances. The reaction product may be separated by ordinary means.

Preferred according to the present invention X′ and Y′ are perfluoromethyl.

In an alternative process, Kashimura teaches a process for forming a bisphenol having fluoroalkyl side chains by reacting the ketone, X′COY′, described hereinabove, with phenol in the presence of a strong acid such as hydrochloric acid or sulfuric acid in the further presence of a catalyst such as ferric chloride, calcium chloride, boric acid, or hydrogen sulfide. Expressly disclosed is a composition wherein X′ and Y′ in structure IX are both perfluoroethyl and A is 4-hydroxy-phenyl.

Hexafluorobisphenol-A is commercially available from Aldrich Chemical Company.

Once the compound of structure IX is prepared, it is then further reacted to form the monomer IIc, according to the process taught in Ding et al., op. cit. In one embodiment thereof is prepared a compound represented by the Structure IId-1,

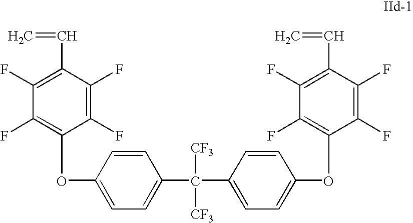

According to Ding et al., IId-1 is prepared by combining 10 molar parts of pentafluorostyrene with 4 molar parts hexafluorobisphenol A in dimethylacetoamide to form a solution. 1.2 molar parts of CsF and 10 molar parts of CaH₂ are added to the solution.

In an alternative method, compound IId-1 is prepared by combining 10 molar parts of pentafluorostyrene with 4 molar parts hexafluorobisphenol A in dimethylacetamide to form a solution. 8 molar parts of K₂CO₃ is added, the resulting solution then being frozen and the air space purged with inert gas. The solution is then heated under reflux at 101° C. for 3 hours, the condensate being caused to pass through a bed of 0.3 nanometer molecular sieves. After cooling, the solution is filtered, evacuated to remove any residual aromatics followed by precipitation in aqueous acid, washing and drying.

According to the practice of the present invention, any of the many embodiments of structure IX prepared as herein described may be substituted for the hexafluorobisphenol A in the process of Ding et al. in order to achieve the full range of monomeric species as represented by Structure IId, or, more generally, in Structure IIc. One of skill in the art will appreciate that in order to achieve optimum reaction conditions it may be necessary to modify the reaction conditions as taught herein.

Ding et al. disclose a polycondensation procedure for preparing fluorinated poly(arylene ether ketone)s from decafluorobenzophenone and hexafluorobisphenol A end-capped with the vinyl groups of pentafluorostyrene that can be crosslinked. The introduction of pentafluorostyrene moieties into the polymer chains at the chain ends or both at chain ends and inside the chain is a two-step reaction conducted in one pot. The first step involves reacting pentafluorostyrene with a large excess of hexafluorobisphenol A to produce a mixture of monosubstituted and disubstituted molecules. Decafluorobisphenol or decafluorobenzophenone is then added to the reaction mixture to obtain the linear polymer with vinyl end-groups.

For the purpose of the present invention, one of the two olefinic moieties of the monomer IId-1 must protected during polymerization by free radical polymerization in order to permit formation of the desired polyolefin of the invention.

The olefinic double bond can be protected according to well-known methods of the art. One such method is the known as the Michael addition which includes the nucleophilic addition of an amine or cyanide ion to an α,β-unsaturated ester to give the conjugate addition product thereby selectively adding to the acryloxy group and leaving the vinyl group on the styrene available for polymerization. Once the polymerization is complete, the amine can be converted into an alkene by first methylating with excess iodomethane to produce a quaternary ammonium iodide which then undergoes an elimination reaction to give back the alkene on heating with silver oxide which is also known as the Hofmann reaction. These methods are described in Orqanic Chemistry, 2^{nd} Ed, by John McMurry, Brooks/Cole Publishing pp. 839-841, 915 (1988).

In another embodiment of Ding is prepared an organic polymer represented by Structure IIc-1

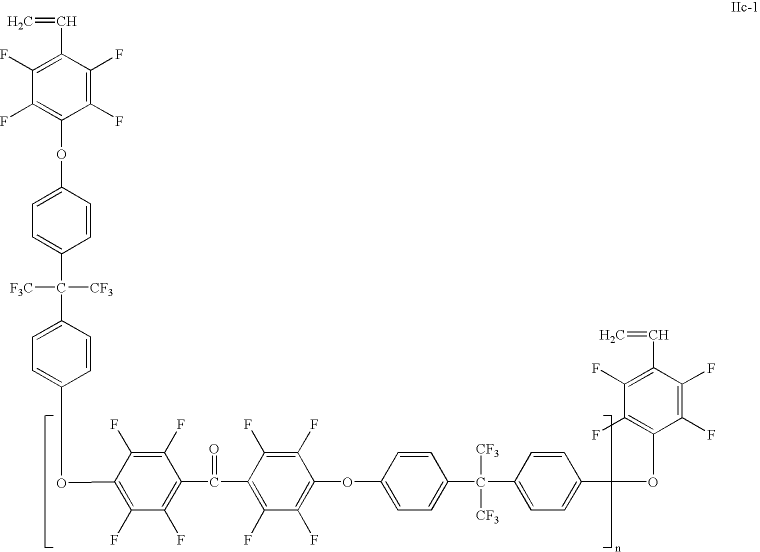

where n is about 24. According to Ding et al., the organic polymer IIc-1 is prepared by first combining 6.6 mmol of pentafluorostyrene with 30 mmol of hexafluorobisphenol-A in dimethylacetamide to form a solution. 1.4 mmol of CsF and 50 mmol of CaH are added to the solution so formed. The resulting solution is frozen and the headspace flushed with argon. The solution is warmed under argon and stirred at 120° C. for 3 hours, followed by cooling. 27 mmol of bispentafluorophenyl ketone dissolved in dimethylacetoamide is then added to the solution, and the resulting solution is then heated to 70° C. for four hours. The solution is filtered and the filtrate precipitated in acidic methanol, followed by washing and drying.

As illustrated by the foregoing synthesis, the focus of Ding et al. is a polyaryl-ether organic polymer in which the olefinic moieties are cross-linkable end groups. Contemplated within the scope of the present invention are organic polymers formed by protecting one of the olefinic moieties in Structure IIc followed by free-radical addition polymerization according to the process hereof of the other olefinic moiety therein to form a polyolefin organic polymer wherein the remainder of the compound IIc is a pendant group or side group on the polyolefin backbone rather than part of the backbone chain as in Ding et al. For the purposes of the present invention, it is desirable to limit the value of n to the range of 0 to 2. Values of n>2 are not practical because the olefinic monomer characterized by n>2 are too difficult to work with. If n>2, then solubility issues may arise and trying to find a solvent that can adequately dissolve the organic polymer while achieving uniform films through spin coating will be problematical.

In order to make the monomer IIc for n=0, the synthesis provided hereinabove for the monomer of Structure IId-1 may be followed. In order to prepare the monomer of Structure IIc wherein n=1 or 2 such as that of monomer IIc-1, it is necessary to alter the stoichiometry of the reactions set out by Ding. Thus, to prepare Structure IIc-1 wherein n=1, the practitioner hereof will first combine 6.6 molar parts of pentafluorostyrene with ca. 30 molar parts of hexafluorobisphenol-A in dimethylacetamide to form a solution. Ca. 1.4 molar parts of CsF and 50 molar parts of CaH are added to the solution so formed. The resulting solution is frozen and the headspace flushed with argon. The solution is warmed under argon and stirred at 120° C. for 3 hours, followed by cooling. 40.5 molar parts of bispentafluorophenyl ketone dissolved in dimethylacetoamide is then added to the solution, and the resulting solution is then heated to 70° C. for four hours. The solution is filtered and the filtrate precipitated in acidic methanol, followed by washing and drying.

The practitioner hereof shall understand that any of the embodiments of compound IX may be substituted for the hexafluorobisphenol-A employed by Ding et al. in the preparation of the monomer IIc when n=1. Similarly, the bispentafluorophenyl ketone may be replaced by numerous compounds wherein one or more of the fluorines therein is replaced by hydrogen, wherein there may be one or more alkyl or fluoroalkyl substituents, and wherein the ketone functionality may be replaced by a bond, an ether, or a hexafluoroisopropenyl radical.

Further provided in the process hereof is a method for preparing the monomer

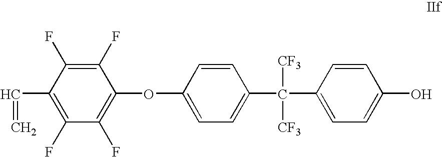

Monomer IIf may be prepared by reacting pentafluorostyrene (PFS) with an excess of hexafluorobisphenol-A in the presence of a weak base such as but not limited to K₂CO₃ or Na₂CO₃. In one embodiment, 1 equivalent of pentafluorostyrene, 3 equivalents of hexafluorobisphenol-A, and 2 equivalents of K₂CO₃ are combined to form a solution in a 2:1 mixture of dimethylacetamide and toluene. After purging the solution with inert gas, the solution is heated to 110-120° C. for 10 minutes, followed by cooling to room temperature. The resulting reaction product is a 4:1 to 5:1 mixture of monomer IIf and monomer IId-1. The product solution is filtered, and the filtrate is contacted with dilute strong acid such as 0.1% HCl to remove residual hexafluorobisphenol-A as a precipitate which is filtered out of the product solution. The aqueous filtrate is extracted by washing with ethyl acetate. After solvent extraction, the organic phase is an oily residue that contains both monomers. The monomers may be separated using column chromatography using a 5:1 hexane:ethyl acetate solvent sweep.

It is particularly important to control reaction temperature, time and starting materials ratio in the process for preparing monomer IIf. Excessively high temperature or long reaction time will lead to the di-functional monomer IId-1 rather than the mono-phenol product IIf. Use of excess 6F-BPA (for example, 3.0 eq. vs 1 eq. of PFS) forces the reaction toward the desired mono-phenol product, increasing reaction selectivity. Reaction temperatures in the range of 80-130° C. and reaction times of 5 to 60 minutes have been found to be satisfactory.

The present invention represents a significant improvement to the art of preparation of optical organic polymers. Optical organic polymers are those that are employed, e.g., in optical frequency communications systems. Typical applications for optical organic polymers include integrated optical devices such as, but not limited to, thermo-optic switches, variable optical attenuators, splitters, couplers, tunable optical filters, optical backplanes and optical power monitors. As discussed hereinabove, one requirement for optical organic polymers is that when fabricated into devices they must exhibit high dimensional stability. This is achieved according to the present invention by causing the organic polymer of the invention to undergo cross-linking after the fabrication of the desired device.

Therefore, in accord with the present invention, is provided a precursor organic polymer which may advantageously be prepared by addition polymerization of one or more species of monomer IIc, either to form a homopolymer as defined herein or a copolymer with one or more species of either of comonomers VIIa and VIIIa, or of both. Said precursor polymer is characterized in that as polymerized it does not contain a cross-linkable functionality because a cross-linkable functionality could interfere with the addition polymerization process by which the polymer of the invention is formed from the monomers herein described.

Further in accord with the present invention is provided a cross-linkable organic polymer, which may advantageously be prepared from said precursor organic polymer by incorporation of a cross-linkable functionality therein. There are numerous means for providing cross-linkable functionality to an organic polymer. In the present invention, in those embodiments wherein, for example, the monomer includes two unsaturated olefinic groups, as in monomer IId-1 or IIc-1, one of the olefinic groups can be protected while polymerization is effected through the other olefinic group. Means for so-protecting the one olefinic group are known in the art as described hereinabove.

Alternatively, in those embodiments wherein the monomer contains only one unsaturated group, as in monomer IIf, there will be no protected unsaturation which can be deprotected to provide a cross-linkable moiety to said organic polymer. Instead, in the case of the organic polymer formed from monomer IIf, the phenolic moiety may be reacted with an additional reagent to add a cross-linkable functionality to said organic polymer. Reagents that may be employed for the purpose of reacting with the phenolic moiety to provide a cross-linkable functionality to said organic polymer include but are not limited to acryloyl chloride. One of skill in the art will appreciate that the addition of these and other unsaturated species such as are known in the art to phenols is well-known chemistry. There are no particular limitations on which such cross-linking agents can be employed to add to the phenolic moiety. Acryloyl chloride and glycidol are preferred since these crosslinking groups are not bulky and easily perform the UV crosslinking. Also, they have fewer CH groups than other cross linkers thereby having minimal effect on optical absorption in the NIR.

One of skill in the art will appreciate that a combination of cross-linkable functionalities and sites is encompassed in the scope of the present invention.

Further provided in the present invention are organic polymers that are cross-linked via at least a portion of the cross-linking sites provided according to the above description. The means for effecting cross-linking include but are not limited to free radical crosslinking using UV or thermal initiators. UV initiators that can be used include but are not limited to Darocur™ 1173, Darocur™ 4265 or Irgacure™ 184. Thermal initiators include but are not limited to benzoyl peroxide, 2,2′-azobisisobutyronitrile, DBU, EDA, etc. Generally 1-5 wt % of initiator is added to the resist formulation, which is spin coated onto silicon wafers. For UV crosslinking, the film is then placed either under vacuum or under a blanket of an inert gas such as N₂. A 200 mJ/cm² UV 365 nm source is then used for crosslinking. Thermal initiated crosslinking involves heating the film under an inert atmosphere or under vacuum.

As described hereinabove, the optical organic polymers known in the art represent various trade-offs among the several requirements for utility in the desired application. The organic polymer of the present invention represents a significant improvement to the art.

It is known in the art that the transparency of organic polymers at near infrared wavelengths, such as the range from 1.3-1.55 μm, is increased when the ratio of C—F bonds to C—H bonds in the organic polymer is increased. However, solubility in ordinary solvents—necessary for cost effective commercial scale processing—is adversely affected when that ratio is made too high. Furthermore, it is further known that an increase in the concentration of C—F bonds is associated with a reduction in the refractive index. In many applications of optical organic polymers it is desired to couple an integrated optical device made from an optical organic polymer with a silica optical fiber or waveguide. Silica's refractive index is 1.44 whereas optical organic polymers known in the art containing a high preponderance of, e.g., monomer units VIII, are characterized by refractive indices below 1.40, resulting in high losses at the coupling interface. Cross-linking functionality usually reduces transparency. It is further known to employ an aromatic moiety to an organic polymer to achieve a higher refractive index, but this may result in an excessively high refractive index with insufficient transparency.

The present invention provides for an organic polymer, which can be precisely tailored to provide the desired optical properties. Consequently, the present invention provides for a method for tuning the refractive index of an organic polymer while maintaining desirably high transparency at near infrared wavelengths, high processability, low orientability, and dimensional stability. According to the present invention, the refractive index in the wavelength range of 1.3 to 1.55 μm is adjusted by adding or subtracting aromatic groups either by varying the composition of the monomer unit II according to the procedures taught herein, or by increasing comonomer content of a fluorostyrenic comonomer. Further according to the present invention the transparency is simultaneously adjusted by increasing the molecular weight as necessary of the perfluoroalkyl moieties either in monomer unit II or by increasing the concentration of perfluoroacrylate comonomer as hereinabove described.

By varying both the composition of the aromatic moieties and the perfluoroalkyl moieties the practitioner hereof is able to attain a formulation that can, for example, effectively maintain the refractive index close to that of silica while preserving low absorption in the near infrared.

By virtue of the present invention, the overall comonomer content in a copolymer prepared according to the present invention may be preserved, thereby substantially preserving such attributes as solubility and processability which depend strongly thereupon, while at the same time optical parameters can be adjusted by variously altering the content of aromatic, fluoroaromatic, and fluoroalkyl moieties in the monomer IIc employed in the process hereof.

According to the method of the invention, one or more organic polymers according to the invention having known properties are employed as a reference standard. It is satisfactory for the practice of the invention to employ those organic polymers herein exemplified. If it is desired to increase the refractive index with respect to the reference standard, then a homopolymer or copolymer according to the invention having a higher concentration of aromatic rings is prepared according the methods herein described. In order to maintain (or increase) the transparency with respect to the reference standard, the aromatic rings are fluorinated, or the length of the fluoroaliphatic chains associated with the organic polymer of the invention is increased. The concentration of aromatic rings, degree of fluorination of the aromatic rings, and length of fluoroaliphatic chains can be independently varied according, for example, to a statistical experimental design, in order to identify that combination of optical and physical properties desired for the particular application. For the first time, all of the needed parameters may be adjusted within a single, stable, highly processibly organic polymer composition.

It shall be understood by the practitioner hereof that there are a plurality of embodiments of the organic polymer of the invention which will exhibit the same refractive index, and the selection of the particular embodiment to be used in a particular application will depend upon the combination of other properties which characterize each of the given embodiments of organic polymer of the invention which are equivalent in refractive index.

The present invention is further described in the following specific embodiments.

### EXAMPLES

In the following examples the following abbreviations and equipment are used.

| | Abbreviation or | Obtained |
|---|---|---|
| Item | Model | From |
| Hexafluorobisphenol A 97% | 6F-BPA | Aldrich |
| Pentafluorostyrene | PFS | Aldrich |
| Dimethylacetamide | DMAc | Aldrich |
| 1H,1H-perfluoro-n-decylacrylate | PFDA | Exfluor |
| | | Research |
| | | Inc. |
| Benzoylperoxide, | BPO | Aldrich |
| Acryloyl Chloride | AC-Cl | Aldrich |
| Triethylamine | TEA | Aldrich |
| Tetrahydrofuran | THF | DuPont |
| 1,8-Diazobicyclo[5.4.0]undec-7-ene | DBU | Aldrich |
| Ethylene diamine | EDA | Aldrich |
| 2,2″-Azobisisobutyronitrile | AIBN | Aldrich |
| 2-Chlorothioxanthen-9-one | ITX | Aldrich |
| P-isopropylphenyl(m-methylphenyl)- | RH-2074 | Rhodia |
| iodoniumtetrakis(pentafluorophenyl)borate | | |
| 3-Acryloxypropyltrimethoxysilane | APTMS | Gelest Inc. |
| n-Propyl Acetate | PrOAc | Aldrich |
| Potassium carbonate, anhydrous | | Aldrich |
| Molecular sieves 3 A° | | Aldrich |
| Oil bath with thermal control system | | Waage |
| | | Electric Inc |
| | | Model No. |
| | | SF45 |
| Rotary Evaporator | Rotavapor R- | Buchi |
| | 205 | |
| Stirrer | | Corning |

The Metricon 2100 prism coupler was used for measuring index of refraction of thin films. This instrument can measure index of refraction to +/−0.0005 under routine conditions and +/−0.0001 under optimal conditions. Index measurements can be made at 4 wavelengths. There are 4 lasers within the instrument. These are at wavelengths 633, 980, 1310, and 1550 nm. The prism coupler measures reflection from the location where the film is pressed onto the prism. This is the coupled spot where the film comes into close contact with the prism. In the “contact spot” the film should come with a fraction of a micron of touching the prism. This allows for evanescent wave coupling of light into the film that is of lower index than the prism. The reflection is monitored as a function of angle. For thin films there are angles that permit light to be launched into propagating modes. The index and thickness of the thin film and the index of the substrate characterize the angles that these modes can be launched. By measuring the angles of enough modes one can fit the data to determine the index and thickness of thin film layers.

Material absorption loss in the NIR region was performed using Diffuse Reflectance Infrared Spectroscopy. The measurements were made with a Varian Cary 5 uv/vis/nir spectrophotometer running WinUV Version 3 software. Varian Cary 5 was equipped with a 110 mm-integrating sphere with a 16 mm sample port. The sphere was coated with polytetrafluoroethylene (PTFE) at a density of 1 g/cc.

A 100% and 0% reflectance baseline was collected prior to sample measurement. Data points are collected every nanometer from 1800 to 900 nm. The sample was loaded into a stainless steel cell with a quartz window. The sample was shaken/packed to achieve the most uniform distribution at the quartz window. The cell was mounted against the sample port. An inspection mirror was used to insure that the sample was covering the entire port. The diffuse reflectance spectrum was collected from 1800 to 900 nm.

### Example 1

### Preparation of p-hydroxy-4,4′-hexafluoroisopropylidenephenol tetrafluorostryene

A three-necked round-bottom flask was equipped with a thermometer, a magnetic stirrer, and a reflux condenser. To remove water from the reaction efficiently, an adapter containing a thimble holding 3 Å molecular sieves was fitted between the reflux condenser and the flask. The reaction reagents were mixed under inert conditions.

A combination of pentafluorostyrene (PFS) (2.0 g, 10.30 mmol, 1.0 eq.), hexafluoro-bisphenol A (6F-BPA) (10.40 g, 30.90 mmol, 3.0 eq.) and K₂CO₃ (2.84 g, 20.60 mmol, 2.0 eq.) was dissolved in a mixture of DMAc (80 ml) and toluene (40 ml). The system was purged with nitrogen for about 10 minutes and then heated to 113° C. for 10 minutes. The reaction was cooled to room temperature, and a small aliquot was then removed from the flask and injected in a GC-MS (Agilent model 6890) equipped with a DB5 column, and employing helium as a sweep gas at a rate of flow 170 ml/min. The GC-MS indicated a concentration ratio of 4.3 of the mono-functional product to the bis-functional by-product. Results also showed that the Product/PFS=22.78 by weight. Most of the PFS was consumed.

Excess K₂CO₃ and KF were removed by vacuum filtration. The filtrate was poured into 1.5 L of 0.1% aqueous HCl solution for neutralization, precipitation and recovery of the residual 6F-BPA. Following filtration of the resulting precipitate, the aqueous phase was then extracted with three 50 ml aliquots of ethyl acetate. Thin layer chromatography (TLC) showed the major and minor products clearly separated. Solvent was removed using the Buchi Rotovap to give a colorless oil as a crude product (4.10 g) containing both major and minor product fractions.

Purification of the crude products was effected by column chromatography using Silica Gel 60 as the solid phase. The mobile solvent was a hexane:ethyl acetate mixture in a 5:1 ratio. The fractions were collected in separate vials and analyzed by TLC to monitor the separation. The major product was 3.35 g of a colorless oil, corresponding to a yield=63.72%. The minor product was collected as 0.52 g of a white solid.

NMR results on the major product were ¹H NMR (CDCl₃, ppm) δ: (d, 2H, 7.3 Ar—H), (d, 2H, 7.15 Ar—H), (d, 2H, 6.9 Ar—H), (d, 2H, 6.75 Ar—H), (dd, 1H, 6.60 Vinyl-H), (d, 1H, 6.15 Vinyl-H), (d, 1H, 5.65 Vinyl-H), (s, 1H, 5.55—OH).

¹⁹F NMR (CDCl₃, ppm) δ: (s, 2F, −155.57 phenyl of PFS), (s, 2F, −143.92 phenyl of PFS), (s, 6F, −64.53, 2-CF₃). ¹³C NMR (CDCl₃, ppm) δ: 63.9 [—C(CF3)-]114.0, 132.0 (phenyl of PFS), 115.2, 115.5, 129, 132 (phenyl of BPA); 122, 123 (—CH═, ═CH₂) 140, 142, 8, 142, 9, 144.6 (q, —CF₃—).

The NMR results are consistent with the major product structure of

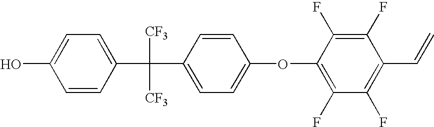

### Example 2

A three-necked round-bottom flask was set up as in Example 1 except that the molecular sieves were not employed. Prior to use in the reaction here described, PFDA and PFS were each injected individually into a purification column containing an “inhibitor remover” (Aldrich Cat. No. 30631, HQ/MEHQ). The purity of the reagents was confirmed by GC-MS. BPO was purified as follows: A 10 weight solution of BPO in methanol was heated to 80-85° C. and held at that temperature for ca. 18 hr to dissolve the BPO. The solution was then cooled to allow crystallization of BPO, and which was collected by vacuum filtration. The BPO was washed with methanol and then air dried for 14 hr. The purity of BPO was confirmed by High Pressure Liquid Chromatography (HPLC). All reaction reagents were mixed in the dry box.

1.84 g (3.61 mmol, 1.0 eq) of the monophenol monomer prepared in Example 1 was combined with 5.60 g of PFS (28.84 mmol, 8.0 eq.), 1.99 g (3.61 mmol, 1.0 q.) of PFDA and 0.224 g of BPO initiator were dissolved in 50 ml of toluene to form a solution. The system was purged with nitrogen for about 10 minutes and then heated to 80˜85° C. and held overnight (ca. 18 hr). The reaction was quenched and allowed to cool to room temperature. Solvent was removed using the Buchi Rotovap to give a colorless gel. The gel so obtained was dissolved in ca. 20 ml of ethyl acetate, and then added dropwise to ca. 800 ml of a cold mixture of hexanes while stirring to precipitate a fine white powder. The solid was filtered out, washed with two 30 ml aliquots of mixed hexanes and dried under vacuum without further purification to yield 5.60 g of product.

NMR showed the desire product. ¹H NMR (CDCl₃, ppm) δ: (m, 2H, 7.28 Ar—H), (m, 2H, 7.09, Ar—H), (m, 2H, 6.88, Ar—H), (m, 2H, 6.74 Ar—H), (s, 1H, 4.98 —OH), (s, 2H,4.34 —OCH₂), (m, 1.0˜3.0, chain —CH₂—CH—). ¹⁹F NMR (CDCl₃, ppm) δ: −161.60, −155.57, 143.87 (phenyl of PFS), −126.63, −124.12, of mono-phenol)

Refractive index, as shown in Table A, was found to be in the range of 1.4499-1.4502. The T_{g} was found to be 78.3° C. and the weight average molecular weight was determined by gel permeation chromatography to be 15,700.

TABLE A

| | Starting Materials | | | | Ratio In | | | | | | | |
|---|---|---|---|---|---|---|---|---|---|---|---|---|
| | PFDA | PFS | Mono | NB # | Organic | Refractive | Optical | | Tg | | | |
| Example | (g) | (g) | phenol (g) | E104961 | polymer | Index* | Absorption | | (° C.) | Td (° C.) | Mw | Solubility |
| 2 | 1.99 | 5.60 | 1.84 | 116 | 80:10:10 | 1.4499~1.4502 | NA | | 78.31 | 367.74 C./91.27% | 15,700 | PA/CP/THF |
| 3 | 2.24 | 7.08 | 2.30 | 123 | 81:10:09 | 1.4516~1.4530 | NA | | 83.08 | 359.34 C./90.42% | 15,000 | PA/CP/THF |
| 4 | 1.37 | 5.68 | 1.80 | 119 | 83:10:07 | 1.4567~1.4575 | NA | | 85.36 | 350.34 C./90.34% | 14,900 | PA/CP/THF |
| 5 | 2.08 | 3.65 | 1.28 | 103 | 75:10:15 | 1.4406~1.4409 | <0.1 | dB/cm | N/A | N/A | N/A | N/A |
| 6 | Organic polymer-OH | | | 112 | 80:10:10 | 1.4499~1.4506 | N/A | | N/A | N/A | N/A | PA/CP/THF |
| ACRY- | 1.57 | | | | | | | | | | | |
| LATE | | | | | | | | | | | | |
| 7 | Organic polymer-OH | | | 141 | 81:10:9 | 1.4538 | 0.05-0.1 | db/cm | 82.54 | 88.00% | 11,500 | PA/CP/THF |
| ACRY- | 15.9 | | | | | | | | | 463.02° C. | | |
| LATE | | | | | | | | | | | | |
| 8 | 2.23 | 6.26 | PFS-Gly | 136 | 80:10:10 | 1.4443 | 0.05-0.1 | dB/cm | 66.21 | 92.70% | 14,000 | PA |
| GLY- | | | monomer | | | | | | | 429.80° C. | | |
| CIDOL | | | 1.0 | | | | | | | | | |

| | | | | | | | | | | |
|---|---|---|---|---|---|---|---|---|---|---|
| 9 | 2.16 | 7.70 | PFS-Gly | 138 | 82:10:8 | 1.4486~1.4490 | 73.22 | 91.50% Wt | 29,700 | PA |
| GLY- | | | monomer | | | | | loss@439.60° | | |
| CIDOL | | | 1.20 | | | | | C. | | |

### Examples 3-5

Additional organic polymers were made according to the method and employing the materials of Example 2, but wherein different relative amounts of the three comonomers were employed with resulting differences in the organic polymer compositions. The specific amounts employed are shown in Table A. The polymer of Example 3 was used to prepare the copolymer with pendant acryloxy crosslinkable functional group.

The refractive index, absorption loss, thermal, and molecular weight data are shown in Table A. FIG. 7 displays graphically the effect of composition on the refractive index. Td, the temperature of decomposition, and Tg, the glass transition temperature, were measured using differential scanning calorimetry according to standard procedures. The solubility column lists the solvent employed in spin coating.

### Example 6

### Preparation of Acryloxy Crosslinkable Organic Polymer

2.0 g of the copolymer prepared in Example 3 was dissolved in 20 ml of THF in a 50 ml three-necked round bottom flask equipped with a dropping funnel, thermometer, condenser and nitrogen inlet. The flask was immersed in a water/dry ice bath. Triethylamine (0.77 g, 7.64 mmol, 10.0 eq.) in 1 ml THF was added in the reaction mixture dropwise using dropping funnel over a 10-minute period. The cooling bath was kept in the range of 0-5° C. A second dropping funnel charged with acryloyl chloride (0.69 g, 7.64 mmol, 10.0 eq.) was quickly substituted in the place of the first now empty dropping funnel to maintain inert conditions within the flask. The reaction was stirred below 10° C. for an additional 3 hours, then quenched. The salt by-product was filtered through a funnel packed with Celite, then washed with two 10 ml aliquots of THF. The combined washings were collected. The solvent was removed by use of the Buchi Rotovaporator under reduced pressure at room temperature. The crude product was yellow.

The equipment and reagents were kept in an inert atmosphere in order to minimize acryloyl chloride hydrolysis.

The crude product so prepared was dissolved in ˜15 ml ethyl acetate, followed by filtration through a 1.0 μm PTFE filter. The filtrate was combined with cold methanol giving a white precipitate that was dried under vacuum to yield 1.23 g.

NMR showed the desired product. ¹H NMR (CDCl₃, ppm) δ: (m, 2H, 7.33 Ar—H), (m, 2H, J=6.76, 7.11 Ar—H), (m, 2H, 6.92, Ar—H), (m, 2H, 6.79, Ar—H), (d, 1H, J=17.17, 6.53, vinyl-H), (t, 1H, J₁=10.08, J₂=27.84, J₃=17.26 6.24, vinyl-H), (d, 1H, J=9.89, 5.96, vinyl-H), (s, 2H, 4.34 —OCH₂), (m, 1.4˜3.0, chain —CH₂—CH—). ¹⁹F NMR (CDCl₃, ppm) δ: −161.60, −154.57, 143.58 (phenyl of PFS), −126.62, −124.13, −123.22, 122.40, 120.58 (—[CF₂]₈ of PFDA), −81.39, (—CF₃ of PFDA), −64.75 (−2CF₃ of mono-phenol)

These results are consistent with the addition of the crosslinkable acrylate group being added to the copolymer. The —OH group gradually disappeared, gradually being replaced by olefin, while the —CF₃ group persisted.

### Example 7

The methods and materials of Example 6 were employed but the concentrations of the starting materials was as follows: 15.9 g of the copolymer prepared in Example 5 was dissolved in 160 ml of THF, triethylamine (6.24 g, 61.7 mmol, 10.0 eq.) in 15 ml THF was added to the reaction mixture dropwise, followed by the addition of 5.58 g of acryloyl chloride. Results are shown in Table A.

### Example 8

In a three-necked 100 ml round bottom flask equipped with condenser, thermal controller, nitrogen inlet and a magnetic stirring bar, 5 g of PFS was combined with 2.3 g of glycidol in 50 ml of dried DMF. To the clear reaction mixture, 3.59 g of K₂CO₃ was added. The resulting mixture underwent a color change from clear and colorless to yellow. The reaction was carried out at 50° C. for 8 hours, GC-MS indicated a product conversion rate of 61.92%. The reaction was quenched by reducing the temperature using an ice bath. 30 ml water was added to the reaction mixture, and the so formed mixture was stirred 5 minutes allowing the K₂CO₃ to dissolve in the water phase. The organic phase was extracted with three 30 ml aliquots of CH₂Cl₂. The organic phase was further washed with 10 ml of 1% HCl and then three 30 ml aliquots of water until pH neutral. Dichloromethane was evaporated under reduced pressure to result in a light yellow oil.

The crude product was purified by column chromatography. Hexane:EtOAc=20:1 and again at 5:1. The impurities were separated from product. The pure product was a colorless oil weighing 2.25 g corresponding to a yield of 35%.

¹H NMR and ¹⁹F NMR showed the desired product. ¹H NMR (CDCl₃): (dd, J₁=11.38 Hz, J₂=18.96 Hz, 1H, 6.51 ppm, vinyl-H), (d, 1H, J=16.11 Hz, 5.92 ppm, vinyl-H), (d, 1H, J=12.34 Hz, 5.53 ppm, vinyl-H), (dd, 1H, J₁=3.35 Hz, J₂=10.98 Hz, 4.38 ppm, CH₂—), (dd, 1H, J₁=6.68 Hz, J₂=11.93 Hz, 4.04 ppm, —CH₂), (m, 1H, 3.23 ppm, epoxy-H), (dd, 1H, J₁=4.67 Hz, J₂=9.12 Hz 2.78 ppm, epoxy-H), (dd, 1H, J₁,=2.44 Hz, J₂=4.67 Hz, 2.5 ppm). ¹⁹FNMR: (d, 2F, −145.25 ppm), (d, 2F, −158.50 ppm).¹³C NMR (ppm)(145.92, 144.00, 142.01, 140.14, 135.99, 122.40, 122.05, 111.29, 75.33, 49.93, 44.00).

### Example 9

A three-necked round-bottom flask was equipped with a thermometer, a magnetic stirrer, and a reflux condenser. The reactants were mixed in a dry box. 7.70 g of PFS, 1.20 g of PFS-Glycidol monomer prepared in Example 8, 2.16 g of PFDA, and 0.31 g of BPO initiator were dissolved in 70 ml of dried toluene. The system was purged with nitrogen for about 10 minutes and the reaction mixture was heated to 75˜80° C. overnight (˜18 hr).

The reaction was quenched by cooling to room temperature. The solvent was removed by Rotovap under reduced pressure to give clear colorless gel. The crude product was dissolved in ˜20 ml ethyl acetate, and then was precipitated in ˜800 ml of cold hexanes to give a fine white powder. The solid was filtered out, washed with hexane (30 ml×2) and dried under vacuum without further purification to give 8.09 g of product.

NMR. ¹H NMR (CDCl₃, ppm) (s, 1H, 4.34 —OCH₂), (s, 1H, 3.99 —OCH₂); (s, 1H, 3.24 Epoxy-H); (s, 1H 2.78 Epoxy-H); (s, 1H, 2.60 Epoxy-H); (m 1.3˜2.5, chain —CH₂—CH—). ¹⁹F NMR (CDCl₃, ppm) δ: (−161.90, −156.81, 143.62 phenyl of PFS), (−126.61, −124.08, 123.18, 122.38, 120.56—[CF₂]₈ of PFDA), −81.21, (—CF₃ of PFDA)

### Example 10

ITX and RH2074 were recrystallized and the purity of ITX, RH 2074 and n-propyl acetate were confirmed by GC-MS. The polymer of Example 9 was dissolved in n-propyl acetate as indicated in Table B. The relative amounts shown in Table B of RH 2074 and ITX were added to the solution and the solution was stirred. The amounts of the reagents used for making the photoresist solution are shown in Table B below. W represents the weight of polymer employed. All other weights are shown in relation to the weight of polymer.

TABLE B

| Chemicals | Suppliers | Quantity (g) |
|---|---|---|
| Polymer | Example 9 | W |
| RH 2074 | RHODIA | 5% W |
| ITX | Sigma Aldrich | 1% W |
| n-propyl acetate | Sigma Aldrich | (W/45%-W) |

### Preparation of Polymer Buffer and Cladding Material Solution

The purity of all reagents was confirmed by GC-MS. The polymer of Example 8 was dissolved in n-propyl acetate. The amount of n-propyl acetate employed for making the solution was calculated based on the weight of polymer as shown in Table C. “W” is defined as above.

TABLE C

| | | CAT | CAS | Quantity |
|---|---|---|---|---|
| Chemicals | Suppliers | number | number | (g) |
| Polymer | Example 8 | — | — | W |
| DBU | Sigma Aldrich | 13,900-9 | 6674-22-2 | 4% W |
| n-propyl | Sigma Aldrich | 53,743-8 | 109-60-4 | (W/45%-W) |
| acetate | | | | |

### Device Fabrication Procedure

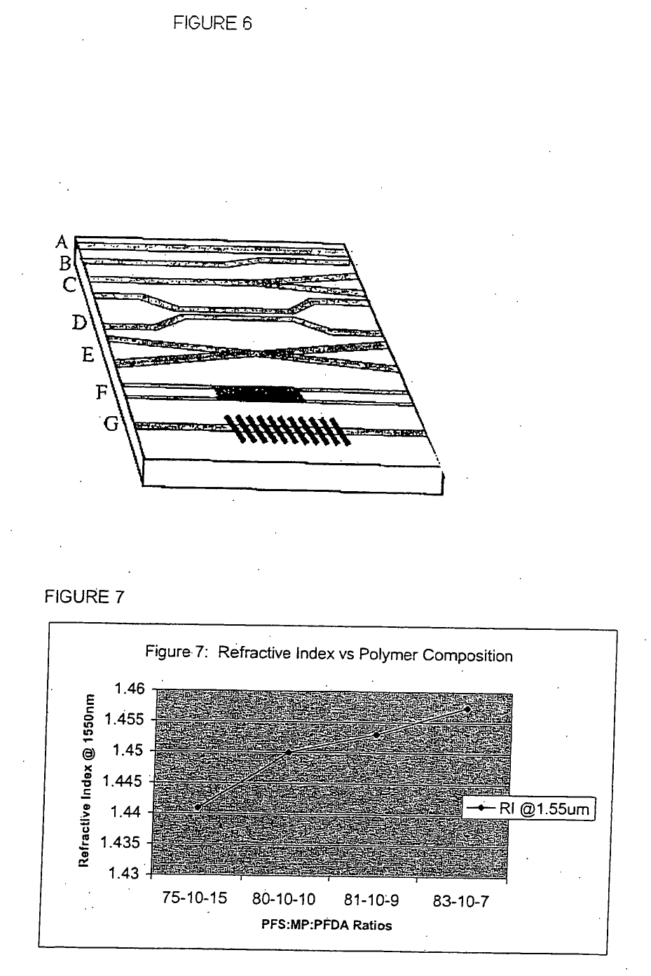

FIG. 2 illustrates a typical process as detailed below for preparing an optical waveguide device employing the polymer found herein. FIG. 6 illustrates various waveguide pattern embodiments which may be created by the process found hereinbelow.

### 1. Silane Adhesion Promoter

A 3-5 ml solution of a 2% by weight of 3-acryloxypropyltrimethoxy silane (Gelest Inc.) in anhydrous methanol (Sigma Aldrich) was spin coated (Headway Research Inc spin coater Model CB15) at 2000 rpm for 30 seconds on an RCA cleaned 4″<100> silicon wafer provided by Silicon Quest International Inc. The wafer was hot plate baked at 110° C. for 3 minutes to ensure complete condensation of silane to the silicon substrate (204).

### 2. Buffer Layer Coating

The buffer solution (203) prepared as above was filtered through a 1.0 μm PTFE filter, followed by filtration through a 0.2 μm PTFE filter. Following filtration, the solution was allowed to relax for 10 minutes to remove all bubbles. A 5 ml quantity of said buffer solution was dispensed onto the center of the wafer that had been silane treated. The solution was spin coated at 800 rpm for 30 seconds to result in a film thickness of about 10-13 μm. The wafer was then placed on a hot plate at 120° C. for 60 minutes. Once the wafer cooled to room temperature, it was treated with an O₂ plasma source (TePLA Reactive Ion Etcher, Model M4L) at 400 Watts, 50 sccm O₂, 2.5% argon flow, with a vacuum of 500 mTorr for 6 minutes.

### 3. Guiding Layer Coating (202)

The guiding layer solution prepared as above was filtered once through a 1.0 μm PTFE filter, then 3 times through a 0.2 μm PTFE filter and allowed to relax for 10 minutes. 5-7 ml of the polymer solution was dispensed onto the center of the plasma-treated coated wafer as prepared in the previous step and spin coated at 1200 rpm for 30 seconds. The film was then hot plate baked at 110° C. for 10 minutes to remove residual solvent from the film. Once cooled, the film was placed in the mask aligner (Optical Associates Inc., Hybralign Series 500), vacuum applied to hold the substrate in place and a dark field mask (205) with various test patterns, consisting of straight waveguides of varying widths from 5.5-150 μm wide, was positioned above the substrate.

The film was exposed at the UV 365 nm for 480 seconds with a power intensity of 200 mJ/cm². The patterned film was then subject to a post-exposure bake on a hot plate at 100° C. for 10 minutes where the pattern can be seen emerging. The substrate was then brought to room temperature and wet-etched using a spray development technique using n-propyl acetate. The substrate was then hard baked at 120° C. for 60 minutes in an N₂-filled oven.

### 4. Cladding Layer Coating (206)

A 10 ml pre-filter solution of the buffer/cladding layer solution above was dispensed onto the substrate, which was swirled to make certain that the solution was in contact with the entire substrate and allowed to penetrate between the waveguides (207). The substrate was spin coated at 700 rpm for 30 seconds, then hot plate baked at 110° C. for 10 minutes, followed by 120° C. for 60 minutes in an N₂-filled oven to complete densification of the cladding layer.

### Optical Test Measurements

Optical loss of the optical waveguide so fabricated was determined as follows. 650-μm light from a laser was introduced into the waveguide specimen by way of an optical fiber coupled to the laser. The fiber was brought up to within about 2 μm of the cleaved end of the waveguide with a piezoelectric driven micro-positioning stage using a microscope fitted with a video camera to monitor the position. A drop of index matching fluid was applied in such manner that both the end of the fiber and the end of the waveguide were thereby coupled. The light which exits the cleaved output facet of the waveguide was collected by a lens and coupled into an integrating sphere fitted with a photodetector.

Measurement of the input light level was made using the lens and integrating sphere to collect light directly exiting the fiber (with the waveguide removed from the optical path). Then the fiber was positioned at the input of the waveguide as described above, and the position of the fiber was adjusted to maximize the output light level of the waveguide.

The light output from the waveguide was then measured for several lengths of the waveguide by progressively cutting the waveguide specimen in half. Measurements of light output at least three waveguide lengths were made.

The logarithm of the ratio of the waveguide light output divided by the waveguide light input was plotted against the waveguide length. The slope of the line thereby described is interpreted as the waveguide loss with units of decibels per centimeter (dB/cm). The vertical intercept of this line (the value of the line extrapolated to a waveguide length of zero) is interpreted as the total coupling losses in units of decibels (dB).

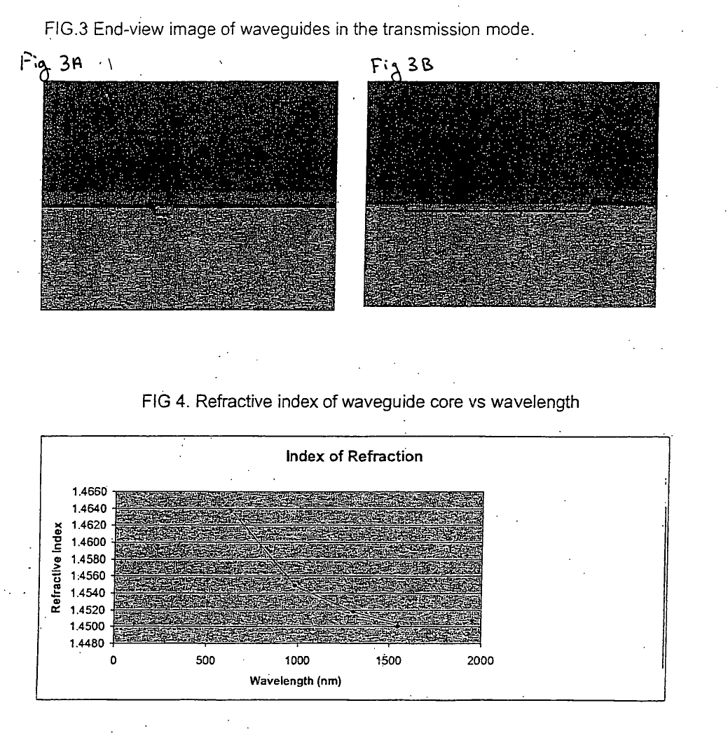

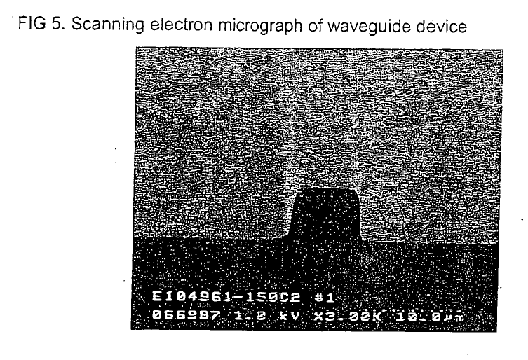

The optical test measurements shown in TABLE D and FIG. 4 are for straight waveguide devices. Refractive index measurements of the waveguide core was determined at 633, 980, 1310 and 1550 nm. Transmission images of 15 and 150 μm wide single-mode waveguides are shown in FIGS. 3A and 3B. A SEM (Hitachi Scanning Electron Microscope, Model S 4000) image of a waveguide is shown in FIG. 5. Waveguide optical measurements were performed via cutback technique.

TABLE D

| | Propagation Loss | |
|---|---|---|
| Wavelength (nm) | (dB/cm) | Coupling Loss Fraction |
| 1550 | 0.248 | 0.262 |
| 1310 | 0.231 | 0.191 |
| 980 | 0.199 | 0.151 |

What is claimed is:

1. An organic polymer comprising monomer units represented by the structure 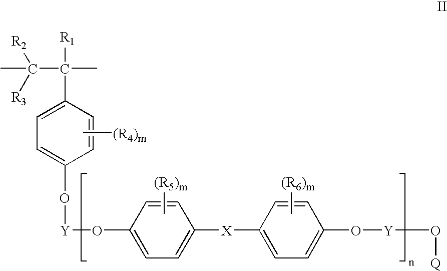
where n is an integer equal to 0 to 2, each of R₁, R₂, and R₃ is independently H, F, or lower alkyl, with the proviso that no more than one of R₁, R₂, and R₃ can be F at one time; each m is independently an integer equal to 0 to 4; each of R₄ is independently F, Cl, or lower fluoroalkyl; each of R₅ is independently H, F, lower alkyl, or lower fluoroalkyl, each of R₆ is independently H, F, lower alkyl, or lower fluoroalkyl; X is a bond, an ether oxygen, a carbonyl, or 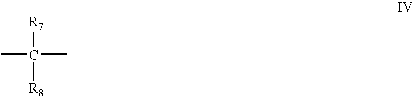
where R₇ and R₈ each is independently H, F, or fluoroalkyl, with the proviso that if R₇ is H or F then R₈ must be fluoroalkyl; Y is a diradical having the formula 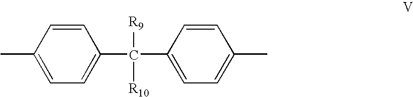
where R₉ and R₁₀ is each independently H, F, or fluoroalkyl, with the proviso that only one of R₉ or R₁₀ may comprise an alkyl or fluoroalkyl chain of more than two carbons, and with the further proviso that if R₉ is H or F, R₁₀ is fluoroalkyl; and, Q is H, an unsaturated group suitable for use as a cross-linking site, or a radical having the formula 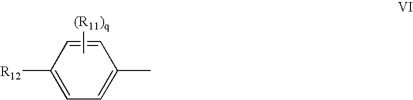
where q=1-4, each of R₁₁ is independently F or H, and R₁₂ is a cross-linkable alkenyl or a protected alkenyl.

2. The organic polymer of claim 1 in the form of a homopolymer.

3. The organic polymer of claim 1 in the form of a copolymer.

4. The organic polymer of claim 1 wherein R₁, R₂, and R₃ are all H.

5. The organic polymer of claim 1 wherein each of R₄ is F.

6. The organic polymer of claim 1 wherein each of R₅ and R₆ are F.

7. The organic polymer of claim 1 wherein each m=4.

8. The organic polymer of claim 1 wherein n=0 or 1.

9. The organic polymer of claim 8 wherein n=0.

10. The organic polymer of claim 1 wherein X is 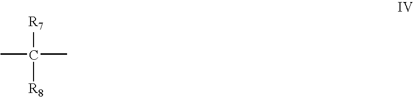
where R₇ and R₈ each is independently H, F, or fluoroalkyl, with the proviso that if R₇ is H or F then R₈ must be fluoroalkyl.

11. The organic polymer of claim 10 R₇ and R₈ are both perfluoromethyl radicals.

12. The organic polymer of claim 1 wherein X is ether oxygen

13. The organic polymer of claim 1 wherein R₉ and R₁₀ are both perfluoromethyl radicals, perfluoroethyl radicals, or one of each.

14. The organic polymer of claim 1 wherein one of R₉ and R₁₀ is a perfluoromethyl or perfluoroethyl radical, and the other is a radical represented by the structure 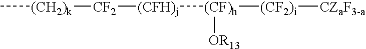
where k=0-2, j=0 or 1, h=0 or 1, i=1-20, Z is F or H, a=0-2, and R₁₃ is a perfluoroalkyl radical of 1-20 carbons, k, i, and a all being integers.

15. The organic polymer of claim 14 wherein one of R₉ and R₁₀ is a perfluoromethyl or perfluoroethyl radical, and the other is selected from the group consisting of
—(CF₂)₁₋₂₀—CF₃,
—CH₂—(CF₂)₁₋₂₀—CF₃,
—CF₂—CFH—(CF₂)₁₋₂₀—CF₃,
—CF₂—CFH—(CF₂)₁₋₂₀—CHF₂,
—CF₂—CFH—CF₃, and

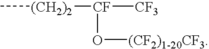

16. The organic polymer of claim 1 wherein Q is H.

17. The organic polymer of claim 1 wherein Q is an unsaturated group suitable for use as a cross-linking site.

18. The organic polymer of claim 1 wherein Q is a radical having the formula 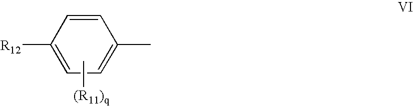
where m is an integer equal to 0 to 4, each of R₁₁ is F or H, and R₁₂ is a cross-linkable alkenyl or a protected alkenyl.

19. The organic polymer of claim 18 wherein each of R₁₁, is F.

20. An organic polymer comprising monomer units represented by the Structure IIa 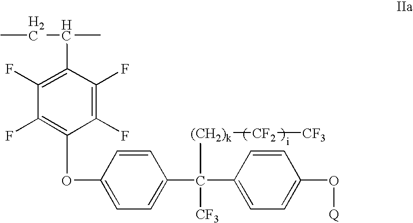
where k=0-2, and i=1-20, k and i being integers, and, Q is H, an unsaturated group suitable for use as a cross-linking site, or a radical having the formula 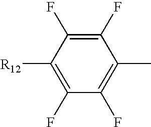
where R₁₂ is
H₂C═CH—
or a protected derivative thereof.

21. The organic polymer of claim 20 wherein said monomer units are represented by the Structure IIb

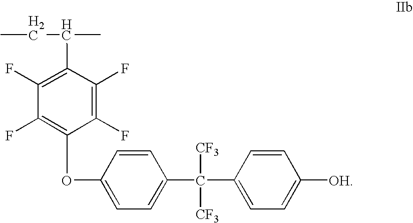

22. The organic polymer of claim 1 further comprising monomer units represented by the Structure VI 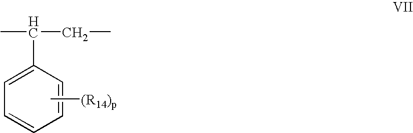
where p is an integer equal to 0 to 5 and each R₁₄ is independently F, Cl, alkyl, fluoroalkyl, alkoxy, and fluoroalkoxy.

23. The organic polymer of claim 22 wherein R₁₄ is F and p=5.

24. The organic polymer of claim 1 further comprising monomer units of the Structure VIII: 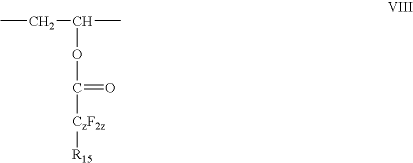
where z is an integer equal to 1 to 20, and R₁₅ is trifluoromethyl or an unsaturated group suitable for use as a cross-linking site.

25. The organic polymer of claim 1 wherein R₁₂ and R₁₅ are diradical residues of unsaturated groups after cross-linking has taken place.

26. An organic polymer comprising 60 to 90 mol-% of monomer units represented by the Structure VII 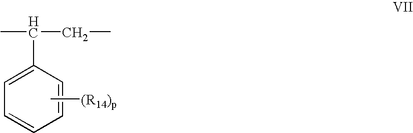
where p is an integer equal to 0 to 5 and each R₁₄ is independently F, Cl, alkyl, fluoroalkyl, alkoxy, and fluoroalkoxy;
to 20 mol-% of monomer units represented by the Structure VIII 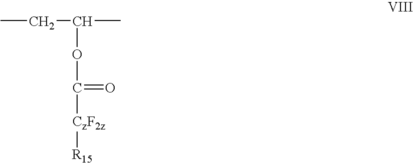
where A is an integer equal to 1 to 20, and R₁₅ is trifluoromethyl or an unsaturated group suitable for use as a cross-linking site;
and,
5 to 20 mol-% of monomer units represented by Structure II 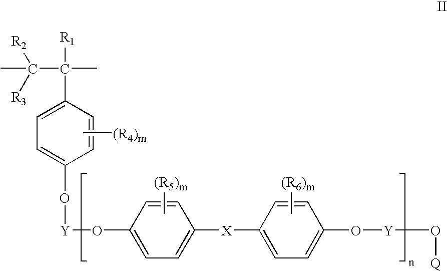
where n is an integer equal to 0 to 2, R₁₋₃ may each be H, F, or lower alkyl, with the proviso that no more than one of R₁₋₃ can be F at one time; each m is independently an integer equal to 0 to 4; each of R₄ is independently F, Cl, or lower fluoroalkyl; each of R₅ is independently H, F, lower alkyl, or lower fluoroalkyl, each of R₆ is independently H, F, lower alkyl, or lower fluoroalkyl; X is a bond, an ether oxygen, a carbonyl, or 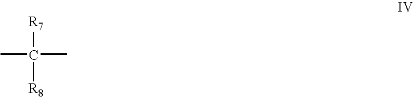
where R₇ and R₈ each is independently H, F, or fluoroalkyl, with the proviso that if R₇ is H or F then R₈ must be fluoroalkyl; Y is a diradical having the formula 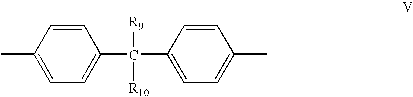
where R₉ and R₁₀ is independently H, F, or fluoroalkyl, with the proviso that only one of R₉ or R₁₀ may comprise an alkyl or fluoroalkyl chain of more than two carbons, and with the further proviso that if R₉ is H or F, R₁₀ is fluoroalkyl; and, Q is H, an unsaturated group suitable for use as a cross-linking site, or a radical having the formula 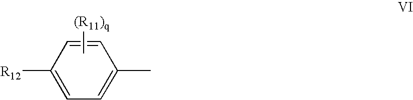
where q=1-4, each of R₁₁ is independently F or H, and R₁₂ is a cross-linkable alkenyl or a protected alkenyl.

27. The organic polymer of claim 26 wherein the monomer unit represented by Structure VII is 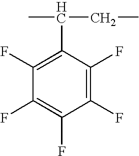
and, the monomer represented by Structure II is [chemical structure]
